(19) United States
(12) Patent Application Publication
(10) Pub. No.: US 2013/0164977 A1
(43) Pub. Date: Jun. 27, 2013

(54) ELECTRICAL CONNECTOR

(71) Applicants: Guang-Li Huang, New Taipei (TW); Li-Jun Xu, New Taipei (TW); Ming-Han Lin, New Taipei (TW)

(72) Inventors: Guang-Li Huang, New Taipei (TW); Li-Jun Xu, New Taipei (TW); Ming-Han Lin, New Taipei (TW)

(21) Appl. No.: 13/334,018

(22) Filed: Dec. 21, 2011

(51) Int. Cl. H01R 13/648

(52) U.S. Cl. 439/607.01

(57) ABSTRACT

An electrical connector includes an insulating housing, a plurality of terminals assembled in the insulating housing, and a shielding shell curved from a metal plate to show a hollow barrel shape and enclose the insulating housing. An inserting space is formed between a front of the insulating housing and periphery inner sides of a front of the shielding shell, and has a free open front end for inserting a mating connector therefrom into the inserting space. The terminals project into the inserting space to connect with the mating connector. A pair of elastic fool-proofing elements is formed at two opposite bottom corners of the open front end of the shielding shell and each shows an arc shape from a front view. Two cambered faces of the elastic fool-proofing elements face each other for guiding the insertion of the mating connector and further elastically resisting against the mating connector.

### BACKGROUND OF THE INVENTION

1. Field of the Invention

The present invention relates to an electrical connector, and more particularly to an electrical connector adapted for connecting with a mating connector.

2. The Related Art

Nowadays, with the development of electronic technology, electronic products and peripheral devices thereof are connected with each other more and more frequently. And it is a kind of common connection way to realize an electrical connection between the electronic product and its peripheral device by virtue of a connector assembly. The connector assembly includes an electrical connector and a mating connector located in the electronic product and its peripheral device respectively. Generally, the electrical connector includes an insulating housing, a plurality of terminals assembled in the insulating housing, and a shielding shell enclosing the insulating housing. An inserting space is formed between a front of the insulating housing and periphery inner sides of a front of the shielding shell. In use, the mating connector is inserted into the inserting space of the electrical connector to realize an electrical connection with the terminals. In order to ensure a proper insertion between the electrical connector and the mating connector, a fool-proofing member is provided for the electrical connector or the mating connector. However, the traditional electrical connector having the fool-proofing member is often hard to meet miniaturization requirements of increasingly improved electronic products.

### SUMMARY OF THE INVENTION

Accordingly, an object of the present invention is to provide an electrical connector adapted for connecting with a mating connector. The electrical connector includes an insulating housing, a plurality of terminals assembled in the insulating housing, and a shielding shell curved from a metal plate to show a hollow barrel shape and enclose the insulating housing. An inserting space is formed between a front of the insulating housing and periphery inner sides of a front of the shielding shell, and has a free open front end for inserting the mating connector rearward therefrom into the inserting space. The terminals project into the inserting space to electrically connect with the mating connector. A pair of elastic fool-proofing elements is formed at two opposite bottom corners of the open front end of the shielding shell and each shows an arc shape from a front view. Two cambered faces of the pair of elastic fool-proofing elements face each other for guiding the insertion of the mating connector and further elastically resisting against the mating connector.

As described above, the elastic fool-proofing elements are formed at the two opposite bottom corners of the open front end of the shielding shell, and have the cambered faces face each other for guiding the insertion of the mating connector and further elastically resisting against the mating connector. So, the elastic fool-proofing elements can ensure a proper insertion between the electrical connector and the mating connector under the condition of making the electrical connector meet miniaturization requirements.

### BRIEF DESCRIPTION OF THE DRAWINGS

The present invention will be apparent to those skilled in the art by reading the following description thereof, with reference to the attached drawings, in which:

FIG. 1 is an assembled perspective view of an electrical connector according to an embodiment of the present invention;

FIG. 2 is a perspective view showing that the electrical connector of FIG. 1 is connected with a mating connector;

FIG. 3 is a perspective view of a shielding shell of the electrical connector of FIG. 1;

FIG. 4 is a front view of the shielding shell of FIG. 3; and

FIG. 5 is a side view of the shielding shell of FIG. 3.

### DETAILED DESCRIPTION OF THE EMBODIMENT

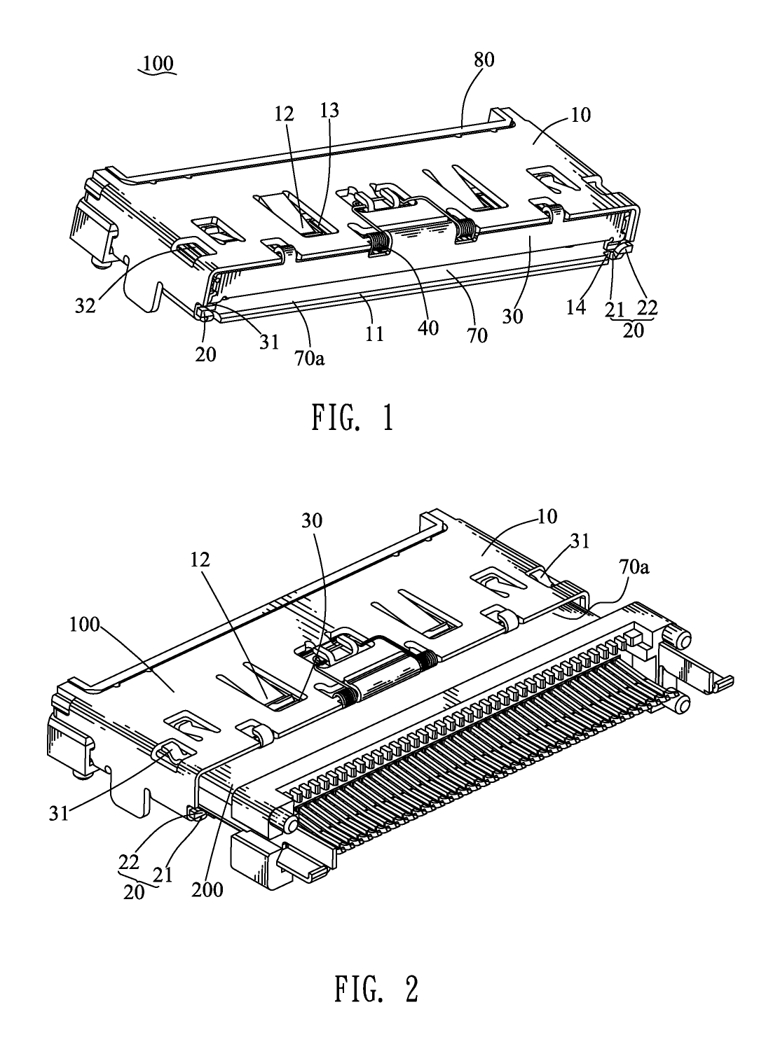

Referring to FIG. 1 and FIG. 2, an electrical connector 100 according to an embodiment of the present invention is adapted for connecting with a mating connector 200. The electrical connector 100 includes an insulating housing 80, a plurality of terminals (not labeled) assembled in the insulating housing 80, and a shielding shell 10 enclosing the insulating housing 80.

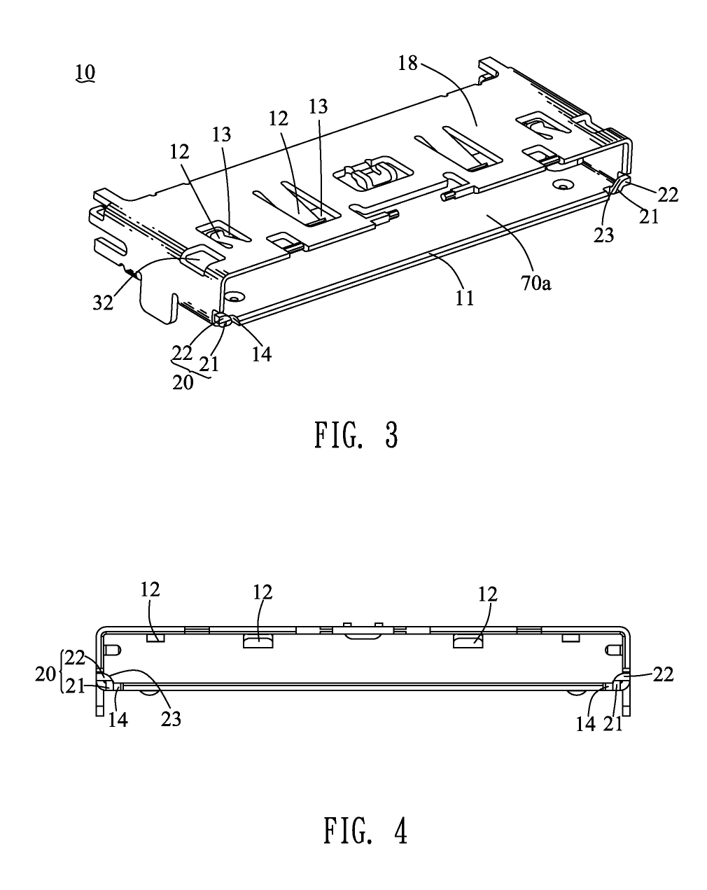

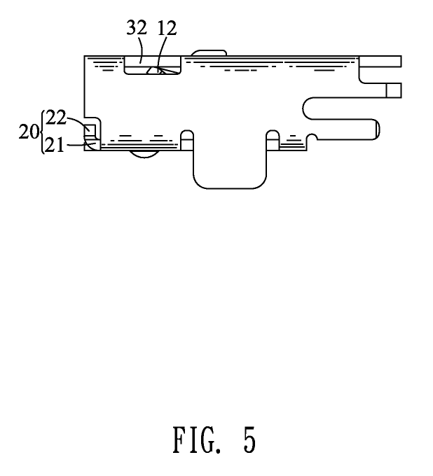

With reference to FIGS. 1-5, the shielding shell 10 is curved from a metal plate to show a hollow barrel shape and enclose the insulating housing 80. An inserting space 70 is formed between a front of the insulating housing 80 and periphery inner sides of a front of the shielding shell 10, and has a free open front end 70a for inserting the mating connector 200 rearward therefrom into the inserting space 70. The terminals project into the inserting space 70 to electrically connect with the mating connector 200. A pair of elastic fool-proofing elements 20 is formed at two opposite bottom corners of the open front end 70a of the shielding shell 10, and each shows an arc shape from a front view. Two cambered faces 23 of the pair of elastic fool-proofing elements 20 face each other for guiding the insertion of the mating connector 200 and further elastically resisting against the mating connector 200.

In detail, two opposite bottom corners of a front periphery edge of the shielding shell 10 are cut off to define two gaps 14. Each of the elastic fool-proofing elements 20 includes a connecting portion 21 protruding in the gap 14 from any edge of the gap 14, and an arc-shaped fool-proofing portion 22 bending sideward into the open front end 70a of the inserting space 70 from a free end of the connecting portion 21. The cambered faces 23 are formed on the fool-proofing portions 22 respectively and face each other.

Referring to FIG. 1 and FIG. 2, the electrical connector 100 further includes a dustproof door 30 which is pivoted to a front end of a top plate 18 of the shielding shell 10 by an elastic member 40. The dustproof door 30 is rotatable between a closed position covering the open front end 70a of the inserting space 70 and an open position rotating rearward under the push of inserting the mating connector 200 rearward into the inserting space 70. The elastic member 40 provides a restoring elasticity force for the dustproof door 30 restoring from the open position to the closed position while the mating connector 200 is withdrawn out of the inserting space 70. Two ends of a bottom of the dustproof door 30 bend rearward and downward to form a pair of blocking portions 31 resisting behind the corresponding elastic fool-proofing elements 20 when the dustproof door 30 is at the closed position. Two sides of the top plate 18 of the shielding shell 10 define a pair of receiving fillisters 32 for receiving the corresponding blocking portions 31 of the dustproof door 30 therein when the dustproof door 30 is pushed rearward by the mating connector 200 to be at the open position.

In this embodiment, the top plate 18 of the shielding shell 10 further defines a plurality of openings 13. Front or rear edges of the openings 13 slantwise extend into the inserting space 70 to define a plurality of elastic arms 12 each having a free end thereof arched downward to resist against the mating connector 200. The front periphery edge of the shielding shell 10 is slantwise broadened outward to form a guiding eave 11 for guiding the mating connector 200 to be inserted into the inserting space 70.

As described above, the elastic fool-proofing elements 20 are formed at the two opposite bottom corners of the open front end 70a of the shielding shell 10, and have the cambered faces 23 face each other for guiding the insertion of the mating connector 200 and further elastically resisting against the mating connector 200. So, the elastic fool-proofing elements 20 can ensure a proper insertion between the electrical connector 100 and the mating connector 200 under the condition of making the electrical connector 100 meet miniaturization requirements.

What is claimed is:

1. An electrical connector adapted for connecting with a mating connector, comprising:
an insulating housing;
a plurality of terminals assembled in the insulating housing; and
a shielding shell curved from a metal plate to show a hollow barrel shape and enclose the insulating housing, an inserting space being formed between a front of the insulating housing and periphery inner sides of a front of the shielding shell and having a free open front end for inserting the mating connector rearward therefrom into the inserting space, the terminals further projecting into the inserting space to electrically connect with the mating connector,
wherein a pair of elastic fool-proofing elements is formed at two opposite bottom corners of the open front end of the shielding shell and each shows an arc shape from a front view, two cambered faces of the pair of elastic fool-proofing elements face each other for guiding the insertion of the mating connector and further elastically resisting against the mating connector.

2. The electrical connector as claimed in claim 1, wherein two opposite bottom corners of a front periphery edge of the shielding shell are cut off to define two gaps, each of the elastic fool-proofing elements includes a connecting portion protruding in the gap from any edge of the gap, and an arc-shaped fool-proofing portion bending sideward into the open front end of the inserting space from a free end of the connecting portion, the cambered faces are formed on the fool-proofing portions respectively and face each other.

3. The electrical connector as claimed in claim 1, further comprising a dustproof door which is pivoted to a front end of a top plate of the shielding shell by an elastic member, the dustproof door being rotatable between a closed position covering the open front end of the inserting space and an open position rotating rearward under the push of inserting the mating connector rearward into the inserting space, the elastic member providing a restoring elasticity force for the dustproof door restoring from the open position to the closed position while the mating connector is withdrawn out of the inserting space.

4. The electrical connector as claimed in claim 3, wherein two ends of a bottom of the dustproof door bend rearward and downward to form a pair of blocking portions resisting behind the corresponding elastic fool-proofing elements when the dustproof door is at the closed position, two sides of the top plate of the shielding shell define a pair of receiving fillisters for receiving the corresponding blocking portions of the dustproof door therein when the dustproof door is pushed rearward by the mating connector to be at the open position.

5. The electrical connector as claimed in claim 1, wherein the shielding shell has a top plate defining a plurality of openings, front or rear edges of the openings slantwise extend into the inserting space to define a plurality of elastic arms each having a free end thereof arched downward to resist against the mating connector.

6. The electrical connector as claimed in claim 1, wherein a front periphery edge of the shielding shell is slantwise broadened outward to form a guiding eave for guiding the mating connector to be inserted into the inserting space.
